(19) United States
(12) Patent Application Publication
(10) Pub. No.: US 2015/0172342 A1
(43) Pub. Date: Jun. 18, 2015

(54) ADAPTIVE VIDEO INSERTION

(71) Applicant: VERIZON AND REDBOX DIGITAL ENTERTAINMENT SERVICES, LLC, BASKING RIDGE, NJ (US)

(72) Inventor: Fenglin Yin, Lexington, MA (US)

(73) Assignee: VERIZON AND REDBOX DIGITAL ENTERTAINMENT SERVICES, LLC, BASKING RIDGE, NJ (US)

(21) Appl. No.: 14/106,922

(22) Filed: Dec. 16, 2013

(51) Int. Cl. H04L 29/06

(52) U.S. Cl. CPC H04L 65/60

(57) ABSTRACT

A method includes receiving a request for a last position in a video program associated with a user of a client device and sending the last position in the video program to the client device. The method includes receiving a periodic update of current position in video program of user from client device, determining whether a secondary video content insertion uniform resource indicator (URI) associated with secondary video content is received. The method also includes sending a response to the client device that includes the secondary video content insertion URI in response to a determination that the secondary video content insertion URI has been received, wherein the client device is configurable to switch from the video program to the secondary video content based on receipt of the secondary video content insertion URI and to switch back to the video program at an end of the secondary video content.

### BACKGROUND

Video service providers currently provide multiple services and programs, including cable television, network television, and video-on-demand content, to their customers. Video service providers manage relationships with their customers using customer accounts that correspond to the multiple services. The video service providers may provide video content to the customers at authenticated and authorized client devices.

A video platform delivers video contents through an adaptive streaming process. In this architecture, video contents are packaged into a presentation of various bit rate video representations corresponding to image pixel width and height, image frames per second, audio languages, closed caption languages, or compression codecs for each short time interval (e.g., a few seconds). These different representations are described in a manifest file, which provides a directory of the available content segments in each video program to a client video application. For video on demand streaming presentation, this manifest file is pre-composed. For live video streaming, the manifest file may be continuously updated, and the client video application may periodically fetch the updated manifest file to determine video segments that are available for playback.

### BRIEF DESCRIPTION OF THE DRAWINGS

FIG. 1 illustrates an exemplary environment in which systems and methods described herein may be implemented;

FIGS. 2A and 2B illustrate respectively, an exemplary adaptive streaming presentation and the adaptive streaming presentation including inserted secondary video content;

FIG. 3 illustrates an exemplary segment of adaptive video streaming presentation of FIG. 2A;

FIG. 4 illustrates an exemplary configuration of one or more of the components of FIG. 1;

FIG. 5 is a diagram of exemplary functional components of the video session server of FIG. 1;

FIG. 6 is a diagram of exemplary functional components of the adaptive video streaming client of FIG. 1;

FIG. 7 is a diagram illustrating data flow for real time insertion of secondary video into an adaptive video streaming presentation; and

FIG. 8 is a flowchart of an exemplary process for inserting secondary video into an adaptive video streaming presentation.

### DETAILED DESCRIPTION OF PREFERRED EMBODIMENTS

The following detailed description refers to the accompanying drawings. The same reference numbers in different drawings may identify the same or similar elements. Also, the following detailed description is exemplary and explanatory only and is not restrictive of the invention, as claimed.

Systems and/or methods described herein may implement real time insertion of secondary video into an adaptive video presentation that is being streamed to a client device (e.g., an online video received at the client device). The systems and architectures may include a video platform that allows real time video insertion of secondary video content, such as advertisements and emergency alerts (e.g., alerts required by the federal emergency alert mandate), into the adaptive video presentation. The systems and methods may be applied to provide control of video insertion into video on demand content.

Consistent with described embodiments, the systems and methods may support video insertion into adaptive video presentations on the video platform for different business models for video service providers. The different business models may include a subscription based model, and an advertisement supplemented model, in which users are required to watch a period of advertisement video in exchange for a subscription fee credit or access to the video content.

As used herein, the terms “user,” “consumer,” “subscriber,” and/or “customer” may be used interchangeably. Also, the terms “user,” “consumer,” “subscriber,” and/or “customer” are intended to be broadly interpreted to include a user device or a user of a user device.

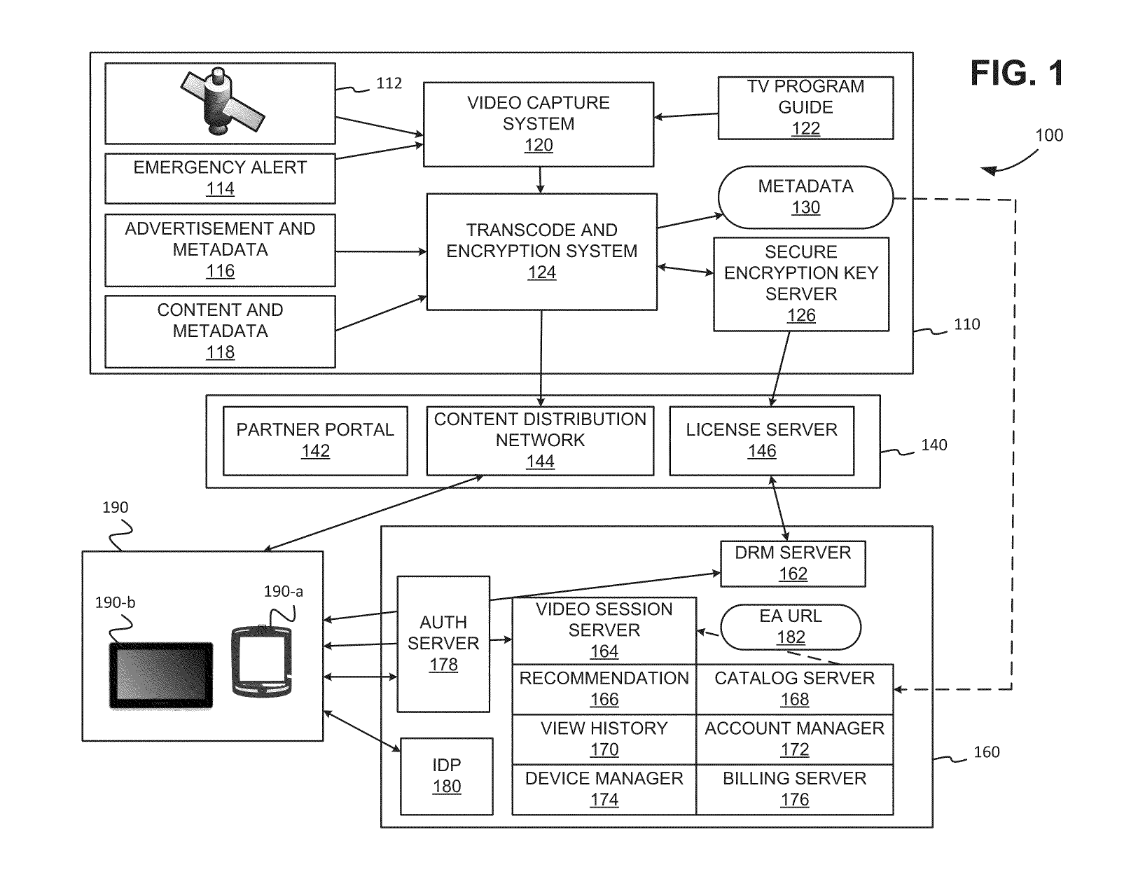

FIG. 1 illustrates an exemplary environment 100 in which systems and/or methods described herein may be implemented. As shown in FIG. 1, environment 100 may include a video processing system 110, a video distribution system 140, a video application system 160, and client devices 190. Devices and/or networks of FIG. 1 may be connected via wired and/or wireless connections.

Video processing system 110 may include (or receive video content, metadata or other information from) one or more content sources 112, an emergency alert (system) 114, an advertisement and metadata (system) 116, and a video content and metadata (system) 118. Video content may include, for example, encoded video content in any of a variety of formats, including, for example, Multiview Video Coding (MVC), Moving Picture Experts Group (MPEG)-2 TS, MPEG-4 advanced video coding (AVC)/H.264. Video processing system 110 may include a video capture system 120, a television (TV) guide information (system) 122, a transcode and encryption system 124, and a secured key encryption server 126.

Video capture system 120 may receive video content from the content sources 112, and emergency alert system 114. The content from the content sources may include channels broadcast by satellite and received at the video capture system 120. Video capture system 120 may capture video streams of each channel and tag the video content with a unique asset id constructed, for example, from channel number, program identifier (ID) and airing time. Video capture system 120 may also capture TV program guide information from a TV guide information system 122.

Transcode and encryption system 124 may transcode and encrypt each asset into different quality levels for streaming and download (e.g., different bit rates and resolution). Transcode and encryption system 124 may transcode and encrypt content from video capture system 120, advertisement and metadata system 116, and video program metadata system 118 based on different rights and protections that the service provider associates/assigns to the different content. Transcode and encryption system 124 may communicate with secured key encryption server 126 to encode each asset that requires encoding with an encryption key. Transcode and encryption system 124 may publish the transcoded and encrypted content to video distribution system 140. Secured key encryption server 126 may publish the encryption keys to video distribution system 140.

Video distribution system 140 may include a partner portal 142, a content distribution network 144 and license server 146. Video distribution system 140 may provide streaming downloads to video client 190.

Partner portal 142 may provide an interface associated with a partner entity to access video content in association with a partner entity. The partner entity may include a sponsorship entity, an entity that provides different types of video content, etc. Partner portal may provide a graphical user interface that accesses systems associated with the partner entity. The partner portal may provide varying levels of access to these systems from customers, partner entity personnel and network administrators associated with the service provider.

Content distribution network 144 may distribute content published by transcode and encryption system to requesting client devices 190. Content distribution network 144 may temporarily store and provide content requested by client devices 190.

License server 146 may provide key and license management. For example, license server 146 may receive a request from a client device 190 for a license relating to video content that client device 190 has downloaded. The license may include information regarding the type of use permitted by client device 190 (e.g., a purchase, a rental, limited shared usage, or a subscription) and a decryption key that permits client device 190 to decrypt the video content or application.

Video application system 160 may include a DRM server 162, a view session server 164, a recommendation (server) 166, a catalog server 168, a view history (server) 170, an account manager 172, a device manager 174, a billing server 176, an authentication server 178 and an identity provider (IDP) 180. Video application system 160 may be a video platform for providing access to an adaptive video streaming presentation via video platform servers (i.e., DRM server 162, view session server 164, recommendation server 166, etc.).

DRM server 162 may apply DRM rules to encrypt content so that only entitled users and authorized devices can consume the video content. For example, DRM server 162 may apply DRM rules associated with particular platforms through which the video content may be distributed. Encrypted content may be distributed through content delivery network 130 or other channels (e.g., via the Internet). Encrypted content may include protections so that the video content may only be consumed by users who have decryption key (e.g., stored in a DRM license) to watch the video content on designated devices which support the DRM protections. DRM server 162 may also encrypt data by DRM rules to enforce particular digital rights (e.g., limited transferability of the video content, limited copying, limited views, etc.). DRM server 162 may apply different DRM rules for different types of content (e.g., different rules for hypertext transfer protocol (HTTP) live streaming (HLS) content and streaming content).

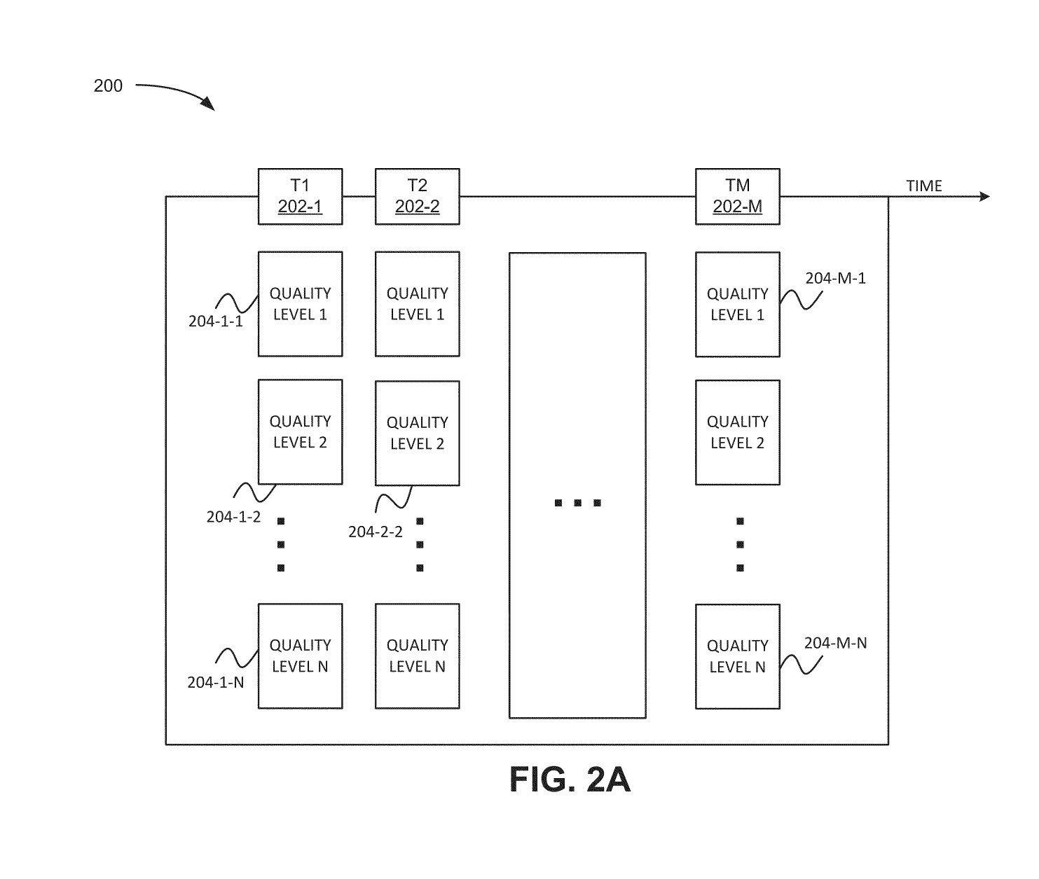

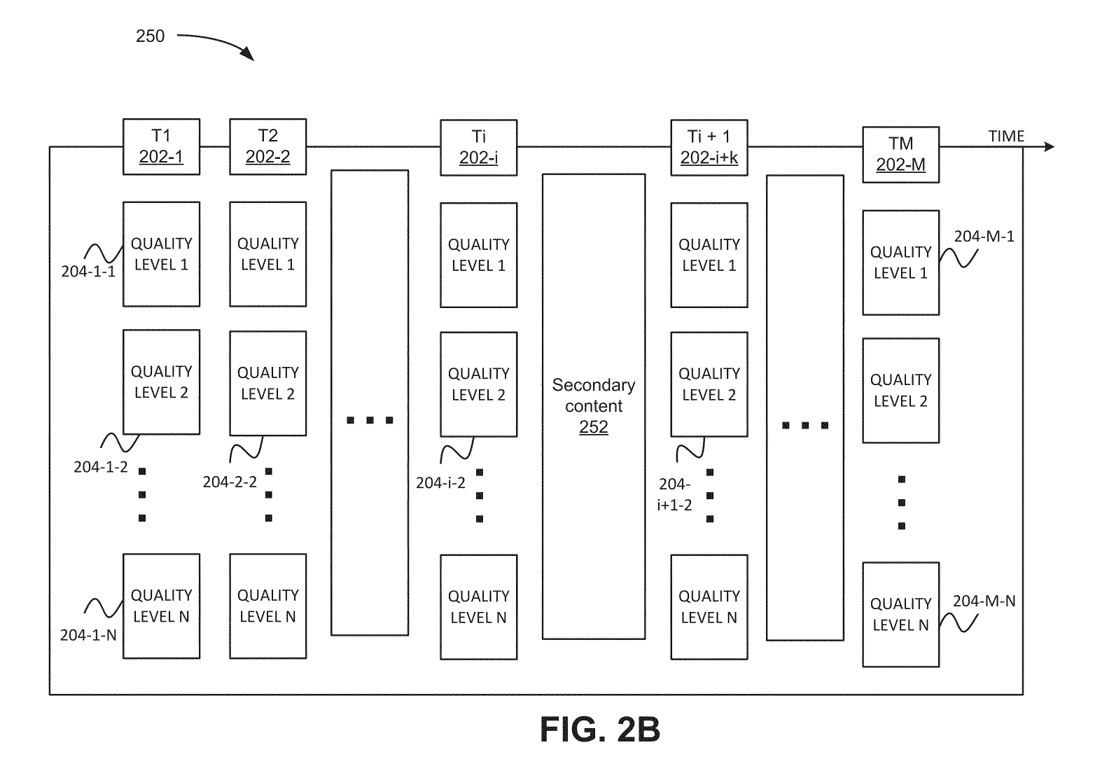

View session server 164 may provide one or more applications that may allow subscribers to browse, purchase, rent, subscribe, and/or view video content. View session server 164 may interact with client device 190 using the HTTP or the secure HTTP (HTTPS). In another implementation, view session server 164 and client devices 190 may interact with one another using another type of protocol. View session server 164 may insert emergency alerts or other secondary video content (e.g., advertisements) into streaming video presentations via an emergency alert (EA) uniform resource locator 182 as described herein, for example with respect to FIGS. 2B and 4 to 8 below.

View session server 164 may also track a user viewing position and allow the user to view video content from a last position that the user has viewed on the same device or different devices. For example, when the user starts to view particular video content, view session server 164 may provide a message with different options for the user to start the video (e.g., from the beginning of the video content or where the video content was stopped the last time the user accessed the video content).

Recommendation server 166 may provide a recommendation engine for video content to be recommended to customers. For example, recommendation server 166 may recommend similar movies to a particular movie that is identified in association with a particular user. In some instances, recommendation server 166 may recommend a list of movies based on the user profile of a user.

Catalog server 168 may provide a catalog of video content for users (e.g., of client devices 190) to order/consume (e.g., buy, rent, or subscribe). In one implementation, catalog server 168 may collect and/or present listings of content available to client devices 190. For example, catalog server 168 may receive digital and/or physical content metadata, such as lists or categories of content, from video distribution system 140. Catalog server 168 may use the content metadata to provide currently-available content options to user devices 170.

View history server 170 may store a transaction history associated with each user and bookmarks associated with video content viewed by the users. Each user's transaction history may include subscriptions, purchases and rentals.

Account manager 172 may store a digital user profile that includes information associated with, related to or descriptive of the user's probable or observed video content activity. Account manager 172 may also store a user login, email, partner customer number, contact information, and other user preference information in association with each user profile.

Device manager 174 may manage client devices 190 associated with each particular user. For example, a user may have multiple associated devices with different capabilities assigned to the devices. Device manager 174 may track authorizations and network connections of the different client devices 190 associated with a user.

Billing server 176 may provide a billing application programming interface (API) (i.e., a billing gateway) to payment and billing processing services. Billing server 176 may manage the process by which a user is charged after he/she buys, rents, or subscribes to a particular item in the video content catalog. In some instances, billing server 176 may bill for a subscription automatically each month. Billing server 176 may provide billing services, such as access to catalog prices and user profiles for recurring subscription charges and other purchase transactions.

Authentication server 178 may support user authentication processes for client devices 190. User Authentication processes may include a login process, user sessions for using authenticated API calls such as user profile access, playback subscription contents, etc.

Identity provider 180 may be an identity provider device that issues and validates identities associated with the partner entity. For example, identity provider 180 may validate login credentials for the user associated with the service provider, a partner entity, etc.

Client devices 190 may include any device capable of communicating via a network, such as content distribution network 144. For example, client devices 190 may include consumer devices such as smartphone devices 190-a (Android mobile, iOS mobile, etc.), and tablets 190-b. Client devices 190 may also include set top boxes, Internet TV devices, consumer electronics devices such as Xbox, PlayStation, Internet-enabled TVs, etc. Client devices 190 may include an interactive client interface, such as a graphical user interface (GUI). Client devices 190 may enable user to view video content or interact with a mobile handset or a TV set.

While FIG. 1 shows a particular number and arrangement of networks and/or devices, in practice, environment 100 may include additional networks/devices, fewer networks/devices, different networks/devices, or differently arranged networks/devices than are shown in FIG. 1.

In implementations described herein, a system and method of insertion of secondary video into an adaptive video streaming presentation (e.g., an online video received at a client device) is disclosed. The systems and architectures may allow real time video insertion into the adaptive video streaming presentation of secondary video content, such as advertisements and emergency alerts (e.g., alerts required by the federal emergency alert mandate).

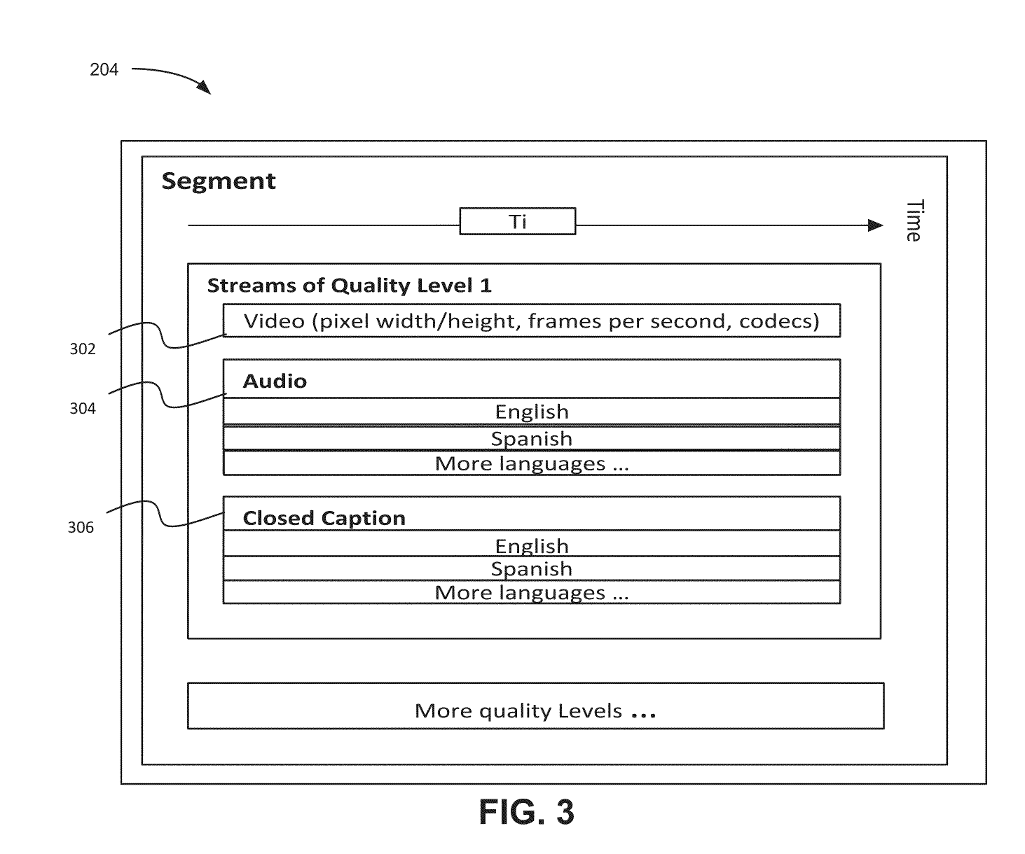

FIG. 2A illustrates an adaptive video streaming presentation 200, such as a movie, television program, etc. Adaptive video streaming presentation 200 may include segments 204 (segments 204-1 to 204-M) of the adaptive video streaming presentation 200 arranged (i.e., which may be received) over time intervals T1 202-1 to TM 202-M. The different segments 204 may be provided at different quality levels (quality levels 1 to quality level m) as described with respect to FIG. 3 and exemplary segment 204.

Adaptive video streaming presentation 200 may include various bit rate segments 204 corresponding to different quality levels (e.g., quality level 1, as shown in FIG. 2). As further shown in FIG. 3, each segment 204 may have particular video characteristics 302 (e.g., image pixel width and height, image frame per second), audio characteristics 304 (e.g., languages, such as English, Spanish, etc.), closed caption languages 306, or compression codecs for each short time interval (t1 to tM) (e.g., each time interval may be a few seconds). Each time interval and corresponding length of the segment may be a limited duration based on processing requirements/conventions for streaming video.

Client device 190 may implement a client video application (i.e., machine-readable instructions) to download the adaptive video streaming presentation 200 from video distribution system 140. Client video application may download segments 204 of the adaptive video streaming presentation 200 for each time period according to real time network bandwidth and device computing capacities of client device 190. The segments 204 are described in a manifest file and include different representations of portions of the video program. In instances of video on demand streaming presentations, the manifest file may be pre-composed and the client device 190 may select segments 204 based on real-time computing capabilities and network bandwidth. In instances of live video streaming, the manifest file may be continuously updated, and client video application may periodically retrieve the manifest file to identify video segments 204 that are available for playback. For example, with respect to FIG. 2A, during a particular video streaming session, client device 190 may select streams of different quality levels (e.g. different video pixel width/height, frames per second, codecs) as the real time network bandwidth and device computing capacities of client device 190 are identified. Client device 190 may select segments 204 of a first quality level (e.g., quality level 1) for some intervals, segments of another quality level in a next time interval (e.g., quality level 2), and segments of other quality levels for other intervals of downloading based on real time network bandwidth and device computing capacities (e.g., central processing unit (CPU) usage) of client device 190.

Depending on device display resolution, real time device processing capacity, and real time network bandwidth, various quality levels of video segments may be transported to client device 190 to maximize user perception of video quality. The entire video program is encoded, packaged and/or encrypted before playback starts on client device 190. In other instances, the video program may be added as the video program progresses until the video program ends. Each period of video representation (i.e., a segment 204 or subgroup of segments 204 of the video program) may be encoded, packaged and/or encrypted in real time. The manifest file in this instance instructs client device 190 to fetch an updated manifest file in a pre-specified time period.

In some instances, the service provider may access secondary video content that the service provider intends to insert into the adaptive video streaming presentation 200 that is (being) provided to client device 190. The systems and methods disclosed allow the real time insertion of secondary video into an adaptive video streaming presentation 200.

FIG. 2B illustrates an adaptive video streaming presentation with inserted secondary video content 250 (e.g., an emergency alert or advertisement) into the adaptive video streaming presentation 200 (e.g., a movie or other video program). The secondary video content 252 may be inserted in an adaptive video streaming presentation, such as adaptive streaming presentation 200 shown in FIG. 2A, in real time as the secondary video content 252 is received.

As shown in FIG. 2B, adaptive video streaming presentation with inserted video content 250 includes segments 204 of different quality levels provided at each time interval 202. In addition to the segments 204 that make up the movie or other video program, adaptive video streaming presentation with inserted video content 250 includes secondary content 252. The secondary content 252 may include emergency alert information, advertising information, etc. The secondary content 252 may be provided via a uniform resource locator (URL) (e.g., EA URL 182) at which the secondary content 252 may be accessed.

The video service provider may insert the secondary content 252 into the adaptive video streaming presentation 200 after a segment 204 at time interval Ti 202-i. Time interval Ti 202-i may be selected based on requirements associated with the secondary content 252. In instances in which the secondary content 252 includes emergency alert information, the secondary content is required to be immediately inserted into the video program and the time interval Ti 202-i may be a present time interval. In other instances, the secondary content 252 may include advertising material that does not require immediate insertion into the video program upon receipt. In these instances, the secondary content 252 may be inserted into the adaptive video streaming presentation at a logical break in the movie or video program (e.g., at the end of a scene or other identified break point (e.g., a content provider or service provider specified/identified break point) of the movie or video program).

After the secondary content 252 has been provided to client device 190, the service provider may switch back to the adaptive streaming presentation at a next time interval (e.g., time interval Ti 202-i+1) that follows the time interval of the last segment 204 shown before the secondary content 252 was provided to client device 190. The presentation may continue streaming in this manner, based on real time network bandwidth and device computing capacities of client device 190. In this manner, no portion of the adaptive video streaming presentation is overlaid with the secondary content (i.e., the user does not miss any of the video program when the secondary content is inserted).

The video service provider may implement insertion of secondary video content 252 into video programs to support a number of different business models for distribution of adaptive video streaming of video content. For example, the insertion of secondary video content 252 into the adaptive video streaming presentation may support a subscription based model for distribution of adaptive streaming video content. Alternatively, the insertion of secondary video content 252 into the adaptive video streaming presentation may support an advertisement supplemented model for distribution of adaptive streaming video content. In the advertisement supplemented model, users may be required to watch a period of advertisement or to allow insertion of secondary content in exchange for a reduced subscription fee or free access to the adaptive video streaming content.

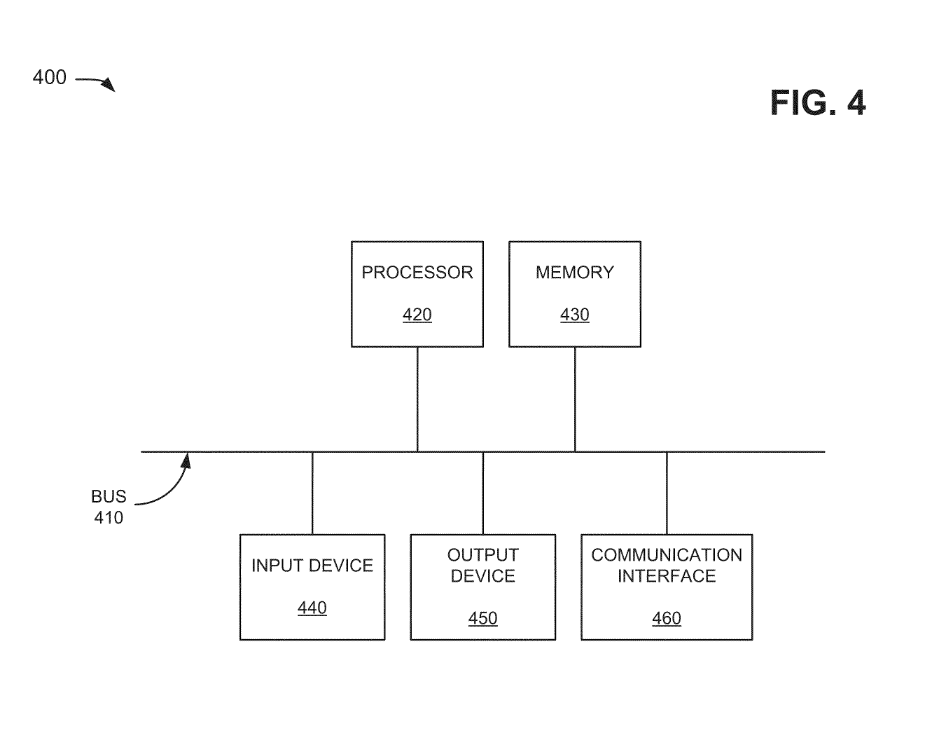

FIG. 4 is a diagram of example components of a device 400. Each of video processing system 110, content source 112, emergency alert system 114, advertisement and metadata system 116, video content and metadata system 118, video capture system 120, TV guide information system 122, transcode and encryption system 124, secured key encryption server 126, video distribution system 140, partner portal 142, content distribution network 144, license server 146, video application system 160, DRM server 162, view session server 164, recommendation server 166, catalog server 168, view history server 170, account manager 172, device manager 174, billing server 176, authentication server 178, identity provider 180 and/or client device 190, may include one or more devices 400. As shown in FIG. 4, device 400 may include a bus 410, a processor 420, a memory 430, an input device 440, an output device 450, and a communication interface 460.

Bus 410 may permit communication among the components of device 400. Processor 420 may include one or more processors or microprocessors that interpret and execute instructions. In other implementations, processor 420 may be implemented as or include one or more application specific integrated circuits (ASICs), field programmable gate arrays (FPGAs), or the like.

Memory 430 may include a random access memory (RAM) or another type of dynamic storage device that stores information and instructions for execution by processor 420, a read only memory (ROM) or another type of static storage device that stores static information and instructions for the processor 420, and/or some other type of magnetic or optical recording medium and its corresponding drive for storing information and/or instructions.

Input device 440 may include a device that permits an operator to input information to device 400, such as a keyboard, a keypad, a mouse, a pen, a microphone, one or more biometric mechanisms, and the like. Output device 450 may include a device that outputs information to the operator, such as a display, a speaker, etc.

Communication interface 460 may include a transceiver that enables device 400 to communicate with other devices and/or systems. For example, communication interface 460 may include mechanisms for communicating with other devices, such as other devices of environment 100.

As described herein, device 400 may perform certain operations in response to processor 420 executing software instructions contained in a computer-readable medium, such as memory 430. A computer-readable medium may be defined as a non-transitory memory device. A memory device may include space within a single physical memory device or spread across multiple physical memory devices. The software instructions may be read into memory 430 from another computer-readable medium or from another device via communication interface 460. The software instructions contained in memory 430 may cause processor 420 to perform processes described herein. Alternatively, hardwired circuitry may be used in place of or in combination with software instructions to implement processes described herein. Thus, implementations described herein are not limited to any specific combination of hardware circuitry and software.

Although FIG. 4 shows example components of device 400, in other implementations, device 400 may include fewer components, different components, differently arranged components, or additional components than depicted in FIG. 4. Alternatively, or additionally, one or more components of device 400 may perform one or more other tasks described as being performed by one or more other components of device 400.

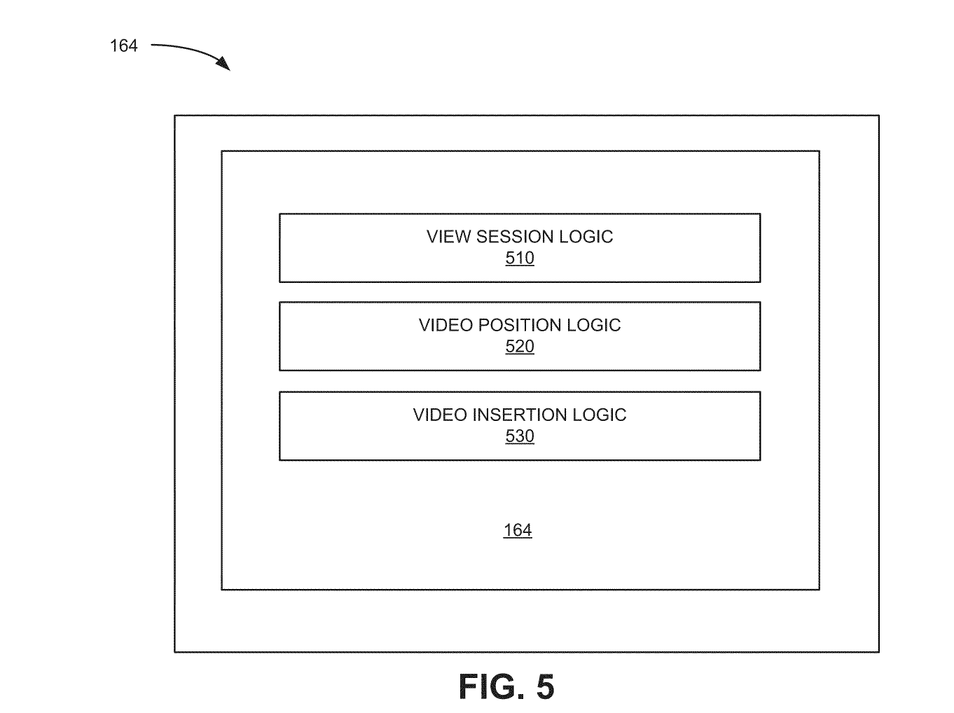

FIG. 5 is a diagram of exemplary functional components of video session server 164. In one implementation, the functions described in connection with FIG. 5 may be performed by one or more components of device 400 (FIG. 4). As shown in FIG. 5, video session server 164 may include video session logic 510, video position logic 520, and video insertion logic 530. Video session server 164 may include other components (not shown in FIG. 5) that aid in receiving, transmitting, and/or processing data. Moreover, other configurations of video session server 164 are possible.

Video session logic 510 may interact with client device 190 to provide access to controlled assets that are distributed by content distribution network 144. Video session logic 510 may establish a session for viewing the video content for the user with client device 190.

Video position logic 520 may periodically receive updates from client device 190 about playback of the adaptive video streaming presentation and a time position in the video program. Video position logic 520 may receive the updates from client device 190 while client device 190 is downloading the adaptive video streaming presentation. Video position logic 520 may store the information received in the updates, including a position in the video program, in association with a user identifier for the particular customer, and, in some instances, an identifier for the client device 190.

Video insertion logic 530 may insert secondary video content into the adaptive streaming presentation to support an emergency alert as required by the federal emergency alert mandate. Video insertion logic 530 may receive provisioning for secondary content via a publication process. In instances in which an emergency alert is required, catalog server 168 may notify video insertion logic 530 with an emergency alert manifest file uniform resource indicator (URI) or URL (i.e., a manifest file for the emergency alert). In instances in which an advertisement is to be inserted, catalog server 168 may notify video insertion logic 530 with pre-scheduled advertisement manifestat file URI. Video insertion logic 530 may include the URIs for the secondary video content in the response header that is sent to client device 190. In some implementations, video insertion logic 530 may include a timing indicator that the client device 190 is to immediately switch to the emergency alert. Alternatively, in instances in which the secondary video content is an advertisement, video insertion logic 530 may include a timing indicator that the client device 190 is to switch to the advertisement at the next (e.g., logical, predetermined, etc.) break point for the video program.

According to an embodiment, video insertion logic 530 may determine whether the client device 190 is to switch to the received advertisement based on information associated with the user of the client device 190, such as information included in transaction history, demographics, preferences, etc.

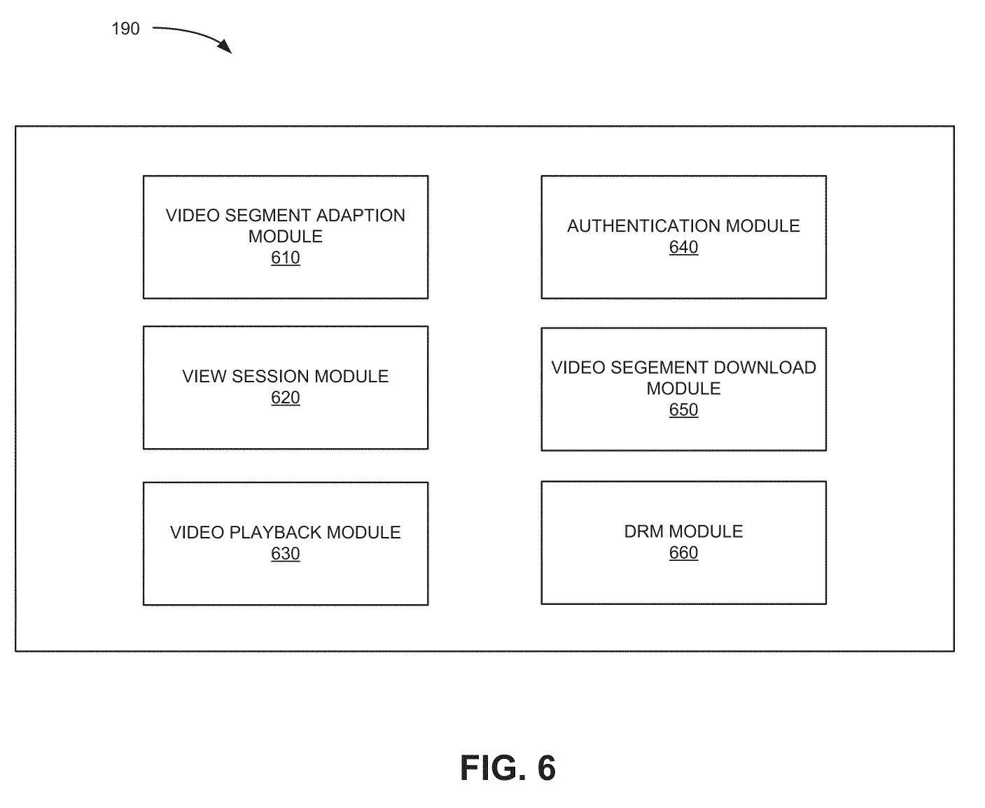

FIG. 6 is a diagram of exemplary functional components of client device 190. In one implementation, the functions described in connection with FIG. 6 may be performed by one or more components of device 400 (FIG. 4). As shown in FIG. 6, client device 190 may include a video segment adaption module 610, a view session module 620, a video playback module 630, an authentication module 640, video segment download module 650 and a DRM module 660.

Video segment adaption module 610 may monitor device CPU usage and network bandwidth. Video segment adaption module 610 may keep track of the time to request and receive the manifest file in instances in which the adaptive video streaming presentation includes live video. Video segment adaption module 610 may determine the URI to download video representation corresponding to a quality level of a segment 204 that client device 190 is able to support/download at that time. Video segment adaption module 610 may monitor published (i.e., posted by the service provider to be inserted into the adaptive video streaming presentation) secondary video content insertion events from view session module 620. If published secondary video content insertion events are found, video segment adaption module 610 may save a current video position to a returning URL and start the process of playing the secondary video content.

View session module 620 may periodically update video session server 164 regarding current playback of the video program and a time position in the video program. View session module 620 may also receive a response from video session server 164 and may check a response header for the response from the video session server 164 to determine whether the response header includes a real time secondary video content insertion URI. In instances in which a real time secondary video content insertion URI is found, view session module 620 may send a secondary video content insertion event to video segment adaption module 610. The secondary video content insertion URI may be a manifest file for an adaptive video streaming presentation of the secondary video content

Video playback module 630 may playback the video segments 204 that are compressed with supported video codecs.

Authentication module 640 may perform authentication processes for the user and client device 190. Authentication module 640 may prompt user to sign into the video platform (i.e., the service provider video system). Authentication module 640 may also provide server authentication tokens when required in communicating with platform servers (e.g., servers in video application system 160, such as DRM server 162, session server 164, recommendation server 166, etc.).

Video segment download module 650 may download segments 204 of the video program identified by video segment adaption module 610. Video segment download module 650 may download video segment files for video, audio, and/or closed caption streams.

DRM module 660 may perform DRM processes associated with the user on client device 190. DRM module 660 may interface with DRM server 162 to retrieve a license for the video program containing usage rights and a decryption key. DRM module 660 may check usage rights for the user and output device security level for client device 190. In instances in which the user and client device 190 are validated (i.e., validation passes), DRM module 660 may decrypt the video stream files for playback.

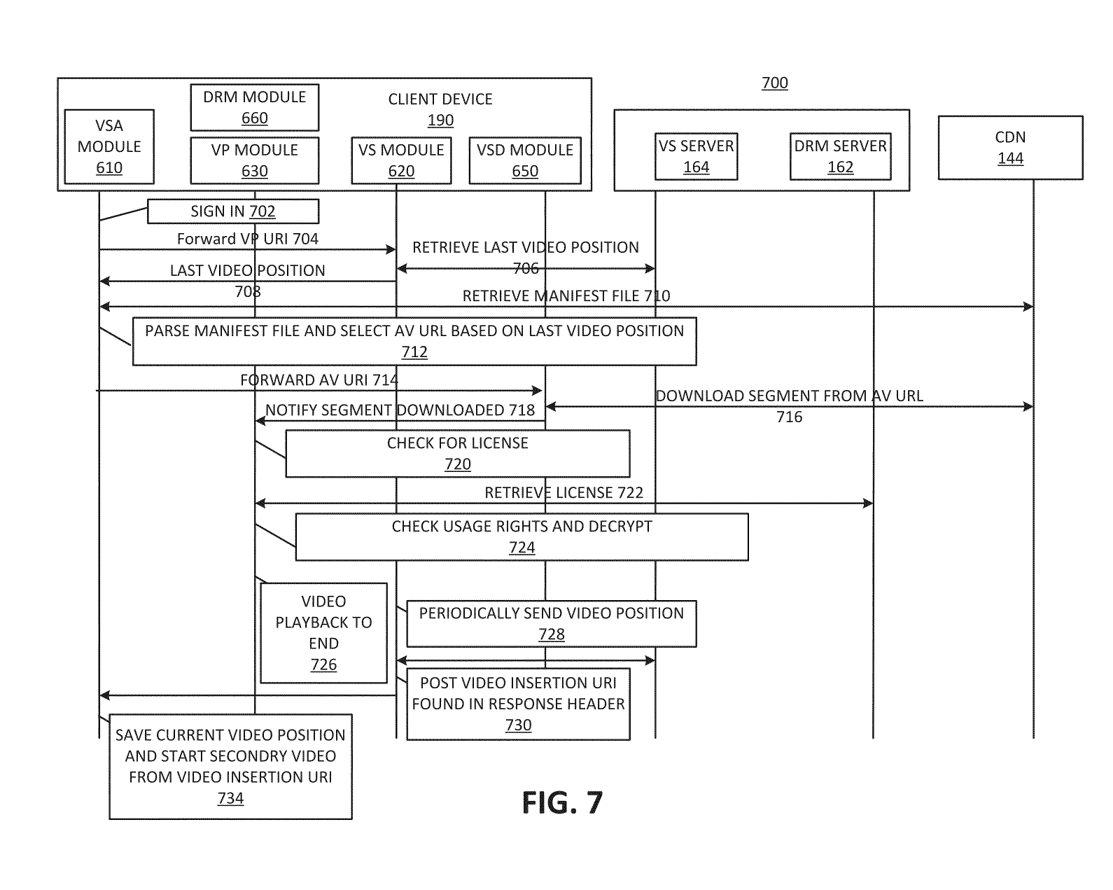

FIG. 7 is a diagram illustrating an application call flow 700 for a process to insert secondary video content into an adaptive video streaming presentation 700. Application call flow 700 may be implemented in an environment such as environment 100, described with respect to FIG. 1, herein above. Application call flow 700 may be implemented between modules of client device 190 (e.g., video segment adaption module (VSA) 610, view session module (VS) 620, video playback module (VP) 630, video segment download (VSD) module 650 and DRM module 660), video platform servers (e.g., video session server 164, DRM server 162, etc.) and content distribution network 144.

As shown in FIG. 7, the application call flow and architectures may support real time video insertion for advertisement and emergency alert with application to adaptive video presentation in an online video. The architectures, application call flow and techniques described may be implemented for video on demand content. All communications in this call flow may be encrypted based on, for example, the HTTPS protocol.

As shown in FIG. 7, application call flow 700 may begin when the user signs into the video application (call flow 702) on client device 190. The user may browse video programs, and start to watch a video program (e.g., an on demand movie or a live show) represented by a video program (VP) URI of an adaptive video streaming presentation. Video segment adaption module 610 may forward the VP URI (call flow 704) to view session module 620. View session module 620 may retrieve a last position viewed for the user (call flow 706). View session module 620 may send the last position viewed to video segment adaption module 610 (call flow 708).

Video segment adaption module 610 may retrieve a manifest file for the adaptive video streaming presentation based on the last position viewed by the user (call flow 710). Video segment adaption module 610 may parse the manifest file. If video segment adaption module 610 may finds a manifest file refresh time interval, video segment adaption module 610 may set a timer for retrieving a subsequent manifest file for the video program (call flow 712). Video segment adaption module 610 may also select an adaptive video (AV) URL based on the last video position. Video segment adaption module 610 may select a URI corresponding to a video quality level that is optimized for user video quality based on screen resolution, CPU usage and network bandwidth. The process of parsing the manifest file and selecting the AV URI may continue while the below described call flows (call flows 714 to 732) are in progress.

Video segment adaption module 610 may forward AV URI to video segment download module 650 (call flow 714). In response, video segment download module 650 may download segments 204 (such as a particular quality level) from AV URL at content distribution network 144 (call flow 716). Video segment download module 650 may notify video playback module 630 and DRM module 620 that the segment 204 has been downloaded (call flow 718).

If the video program is encrypted, DRM module 620 may check a license library stored on (or in association with) client device 190 for a license to the video program (call flow 720). If a license is not found or an invalid license is found, DRM module 620 may retrieve (or attempt to retrieve) a new license from DRM server 162 (call flow 722).

DRM module 620 may check usage rights for the user and output security level (call flow 724). Upon successful validation, DRM module 620 may retrieve the decryption key and decrypt the video file for playback.

Video playback module 630 may playback the adaptive video streaming presentation (the video program) to the end of the video program (call flow 726). At the end of the video program, video playback module 630 may check for a returning URI. If video playback module 630 finds a returning URL, video playback module 630 may set the returning URL to null (i.e., to a start position), and require the process to start over at call flow 702 to repeat the process for new video programs.

While call flows 702 to 726 are repeating, view session module 620 may periodically send video being played and playing time position to the video session server 164 (call flow 728). View session module 620 may receive a response from video session server 164. View session module 620 may checks the response header. In instances in which view session module 620 finds a secondary video content insertion URI in the response header, view session module 620 may post the secondary video content insertion URI to the video segment adaptation module 610 (call flow).

Video segment adaption module 610 may identify secondary video content insertion URI corresponding to a manifest file for the secondary video content. Upon receiving the insertion event (i.e., secondary video content insertion URI), video segment adaption module 610 may save the current URI of the adaptive video streaming presentation to the returning URI, and start the call flow at 702 with the secondary video content insertion URI as a new VP URI (call flow 732). The process may be repeated from call flows 702 through 732 for the secondary video content. When the inserted secondary video content is finished, the video program may resume at the returning URI.

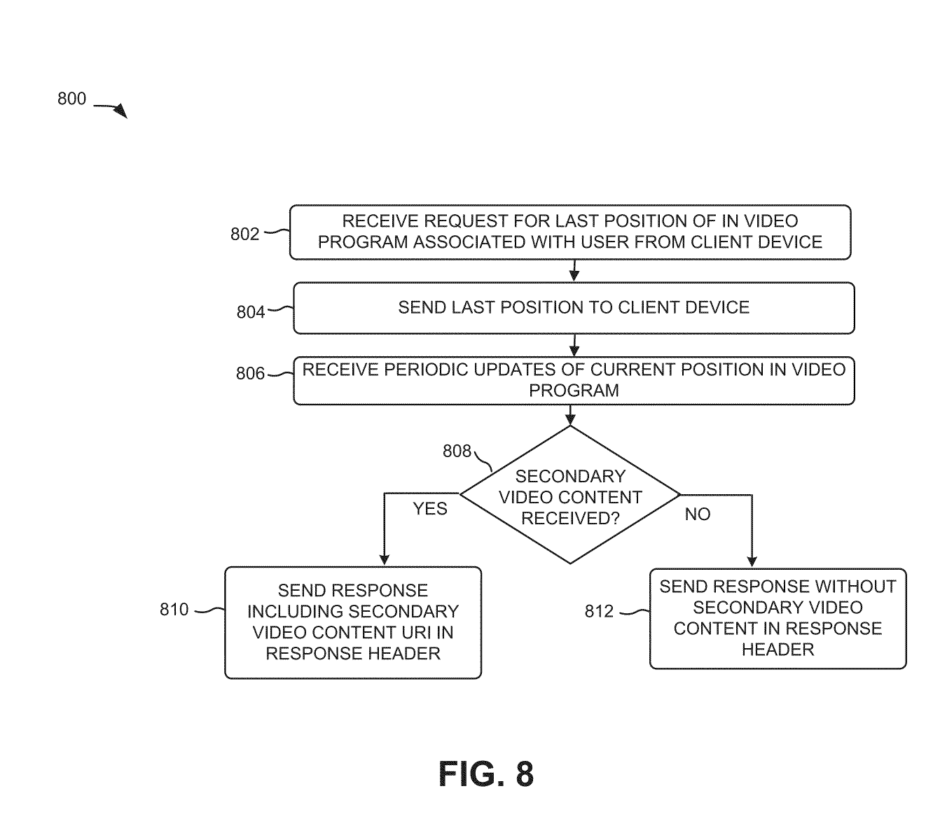

FIG. 8 is a flowchart of an exemplary process 800 for inserting secondary video into an adaptive video streaming presentation. Process 800 may execute in video session server 164. In another implementation, some or all of process 800 may be performed by another device or group of devices, including or excluding video session server 164. It should be apparent that the process discussed below with respect to FIG. 8 represents a generalized illustration and that blocks/steps may be added or existing blocks/steps may be removed, modified or rearranged without departing from the scope of process 800.

At block 802, video session server 164 may receive a request for a last position viewed in a video program by a user (i.e., a last position associated with the user). For example, video session server 164 may receive the request from client device 190 when the user signs in on client device 190 and requests to watch the video program.

At block 804, video session server 164 may send the last position viewed for the user to the client device 190.

Video session server 164 may receive periodic updates of the video program being played by client device 190 and a position in the video program (block 806). For example, client device 190 may send the updates while playing the adaptive video streaming presentation. Video session server 164 may store the received position as a last position of the user for the video content.

At block 808, video session server 164 may determine whether secondary video content (e.g., a secondary video content insertion URI) is received from video processing system 110 to be inserted into the video program. For example, transcode and encryption system 124 may send metadata 130 including the secondary video content insertion URI (such as EA URL 182) to video session server 164.

At block 810, in response to a determination that a secondary video content insertion URI has been received (block 808—yes), video session server 164 may send a response to client device 190 that includes the secondary video content insertion URI in the response header. The client device 190 may switch from the currently viewed video program to the secondary video content.

If a secondary video content insertion URI has not been received (block 808—no), video session server 164 may send a response to client device 190 that includes a response header without a secondary video content insertion URI (block 812).

Systems and/or methods described herein may implement real time insertion of secondary video into an adaptive video presentation that is being streamed to a client device. The systems and architectures may include a video platform that allows real time video insertion of secondary video content, such as advertisements and emergency alerts into a video program. The client device may switch from the video program to the secondary video content based on receipt of a secondary video content insertion URI and to switch back to the video program at an end of the secondary video content.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIG. 8, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions of the invention may be implemented as a “component” or “system” that performs one or more functions. These components/systems may include hardware, such as a processor, an ASIC, or a FPGA, or a combination of hardware and software.

No element, act, or instruction used in the present application should be construed as critical or essential to the embodiments unless explicitly described as such. Also, as used herein, the articles “a”, “an” and “the” are intended to include one or more items. Further, the phrase “based on” is intended to mean “based, at least in part, on” unless explicitly stated otherwise.

What is claimed is:

1. A computer-implemented method comprising:
receiving, from a client device at a server device, a request for a last position in a video program associated with a user of the client device;
sending the last position in the video program to the client device;
receiving a periodic update of current position in video program of user from client device;
determining whether a secondary video content insertion uniform resource indicator (URI) is received, wherein the secondary video content insertion URI is associated with secondary video content; and
sending a response to the client device that includes the secondary video content insertion URI in response to a determination that the secondary video content insertion URI has been received, wherein the client device is configurable to switch from the video program to the secondary video content based on receipt of the secondary video content insertion URI and to switch back to the video program at an end of the secondary video content.

2. The computer-implemented method of claim 1, further comprising:
sending a response to the client device that does not include the secondary video content insertion URI in response to a determination that the secondary video content insertion URI has not been received.

3. The computer-implemented method of claim 1, wherein the secondary video content is an emergency alert.

4. The computer-implemented method of claim 3, further comprising:
sending a timing indicator that indicates that the client device is to immediately switch to the emergency alert.

5. The computer-implemented method of claim 1, wherein the secondary video content is an advertisement.

6. The computer-implemented method of claim 5, further comprising:
sending a timing indicator that the client device is to switch to the advertisement at a next break point in the video program.

7. The computer-implemented method of claim 5, further comprising:
determining whether to insert the advertisement based on information associated with the user.

8. The computer-implemented method of claim 1, wherein the secondary video content insertion URI comprises a manifest file for an adaptive video streaming presentation of the secondary video content.

9. The computer-implemented method of claim 1, wherein the client device is to start an adaptive video streaming presentation of the video program at the last position in the video program in response to receiving the last position from the server device.

10. The computer-implemented method of claim 1, further comprising:
receiving provisioning of the secondary video content via a notification from a catalog server device.

11. A client device, comprising:
a memory to store a plurality of instructions; and
a processor configured to execute the instructions in the memory to:
receive sign on information for a user associated with the client device;
receive a request for a video program from the user;
request a last position in the video program associated with the user from a video session server device;
play the video program from the last position;
send an update of a current position in the video program to the video session server device;
receive a response from the video session server device, wherein a response header for the response includes a secondary video content insertion uniform resource indicator (URI); and
switch from the video program to the secondary video content based on receipt of the secondary video content insertion URI.

12. The device of claim 11, wherein the processor is further to:
switch back to the video program at an end of the secondary video content.

13. The device of claim 11, wherein, when receiving the secondary video content, the processor is further to:
receive an emergency alert.

14. The device of claim 13, wherein the processor is further to:
receive a timing indicator that indicates that the client device is to immediately switch to the emergency alert.

15. The device of claim 11, wherein, when receiving the secondary video content, the processor is further to:
receive an advertisement.

16. The device of claim 15, where the processor is further to:
receive a timing indicator that the client device is to switch to the advertisement at a next break point in the video program.

17. The device of claim 14, where the processor is further to:
present a download status associated with the video content chapters in a graphical user interface associated with the device.

18. The device of claim 11, wherein, when playing the video program from the last position, the processor is further to:
retrieve a manifest file based on the last position in the video program; and
determine a URI corresponding to an optimized quality level based on the manifest file.

19. The device of claim 18, wherein the processor is further to:
set a current playback URI for the video program to a returning URI and start the secondary video content.

20. A system, comprising:
a video session server configured to store a last position in a video program associated with a user;
a content distribution network to provide a manifest file for the video program and segments for the video program; and
a client device including a memory to store a plurality of instructions; and
receive sign on information for a user associated with the client device;
receive a request for the video program from the user;
request a last position in the video program associated with the user from a video session server device;
request segments of the video program from the content distribution network based on the last position;
play the video program from the last position;
send an update of a current position in the video program to the video session server;
receive a response from the video session server wherein a response header for the response includes a secondary video content insertion uniform resource indicator (URI); and
switch from the video program to the secondary video content based on receipt of the secondary video content insertion URI.
